(19) United States
(12) Patent Application Publication
(10) Pub. No.: US 2025/0148654 A1
(43) Pub. Date: May 8, 2025

(54) SYSTEM AND METHOD FOR LEARNED IMAGE COMPRESSION WITH PRE-PROCESSING

(71) Applicants: Douyin Vision (Beijing) Co., Ltd., Beijing (CN); Bytedance Inc., Los Angeles, CA (US)

(72) Inventors: Meng Wang, Beijing (CN); Kai Zhang, San Diego, CA (US); Li Zhang, San Diego, CA (US)

(21) Appl. No.: 19/012,075

(22) Filed: Jan. 7, 2025

Related U.S. Application Data
(63) Continuation of application No. PCT/CN2023/106067, filed on Jul. 6, 2023.

(30) Foreign Application Priority Data
Jul. 7, 2022 (WO) PCT/CN2022/104313

(51) Int. Cl. G06T 9/00; G06N 3/0455

(52) U.S. Cl. CPC G06T 9/002; G06N 3/0455

(57) ABSTRACT

A method for processing video data is disclosed. The method includes: performing a conversion between visual media data and a bitstream of the visual media data by an image compression framework, wherein the image compression framework includes a preprocessing function and a compressor, and the visual media data is processed by the preprocessing function and the compressor sequentially, and wherein the preprocessing function receives a first image among the visual media data with a size of W0×H0×C0 as input and outputs a preprocessed first image with a size of W1×H1×C1, wherein W0 is an input width, H0 is an input height, and C0 is an input channel number, and wherein W1 is an output width, H1 is an output height, and C1 is an output channel number.

### CROSS-REFERENCE TO RELATED APPLICATIONS

This application is a continuation of International Patent Application No. PCT/CN2023/106067, filed on Jul. 6, 2023 which claims the priority to and benefits of International Patent Application No. PCT/CN2022/104313, filed on Jul. 7, 2022. The entire disclosure of the aforementioned applications is incorporated by reference as part of the disclosure of this application.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data including: determining to apply a preprocessing function to visual media data as part of an image compression framework; and performing a conversion between the visual media data and the bitstream based on the image compression framework.

Optionally, in any of the preceding aspects, another implementation of the aspect provides that the preprocessing function receives a current image of size W0×H0×C0, where W0 is an input width, H0 is an input height, and C0 is an input channel number, and wherein the preprocessing function outputs the current image with a size of W1×H1×C1, where W1 is an output width, H1 is an output height, and C1 is an output channel number.

Optionally, in any of the preceding aspects, another implementation of the aspect provides that W0 is equal to W1, H0 is equal to H1, and C0 is equal to C1.

Optionally, in any of the preceding aspects, another implementation of the aspect provides that C0 is not equal to C1.

Optionally, in any of the preceding aspects, another implementation of the aspect provides that W0 is not equal to W1 or H0 is not equal to H1.

Optionally, in any of the preceding aspects, another implementation of the aspect provides that the preprocessing function includes a deep neural network that employs parameters determined through deep learning.

Optionally, in any of the preceding aspects, another implementation of the aspect provides that the preprocessing function includes convolutional layers that employ a kernel size of 3×3, 4×5, or 7×7, and wherein the convolutional layers employs dilated convolution with a dilated parameter set to three, five, or seven.

Optionally, in any of the preceding aspects, another implementation of the aspect provides that the preprocessing function includes residual blocks, wherein the residual blocks contain a convolutional layer, an activation layer, a batch normalization layer, or combinations thereof.

Optionally, in any of the preceding aspects, another implementation of the aspect provides that the preprocessing function includes swin-transformers, and wherein a head number of the swin-transformers is two or six, and wherein a depth of the swin-transformers is set to two or six.

Optionally, in any of the preceding aspects, another implementation of the aspect provides that the preprocessing function includes dense connected structures.

Optionally, in any of the preceding aspects, another implementation of the aspect provides that the image compression framework includes a compressor, and wherein the preprocessing function is jointly optimized with the compressor.

Optionally, in any of the preceding aspects, another implementation of the aspect provides that the compressor is a learning based variational auto-encoder.

Optionally, in any of the preceding aspects, another implementation of the aspect provides that the learning based variational auto-encoder is partially trained prior to training the preprocessing function, and wherein the learning based variational auto-encoder and the preprocessing function are jointly trained.

Optionally, in any of the preceding aspects, another implementation of the aspect provides that the compressor is a proxy auto encoder with fixed model parameters.

Optionally, in any of the preceding aspects, another implementation of the aspect provides that the preprocessing function includes multiple models directed to different coding bit rates.

Optionally, in any of the preceding aspects, another implementation of the aspect provides that the preprocessing function is configured to adapt to different bitrates based on a quantization parameter, a coding controlling parameter, or combinations thereof.

Optionally, in any of the preceding aspects, another implementation of the aspect provides that the proxy auto encoder includes a prediction function, a transformation function, an inverse transformation function, a quantization function, and a rate estimation function.

Optionally, in any of the preceding aspects, another implementation of the aspect provides that the proxy auto encoder includes a restoration neural network.

Optionally, in any of the preceding aspects, another implementation of the aspect provides that the compressor includes a hybrid codec that further includes a codec and a learning-based function, and wherein the learning-based function includes learning-based in-loop filters, learning-based intra prediction, learning-based inter prediction, learning-based quantization, or combinations thereof.

A second aspect relates to an apparatus for processing video data including: a processor; and a non-transitory memory with instructions thereon, wherein the instructions upon execution by the processor, cause the processor to perform any of the preceding aspects.

A third aspect relates to a non-transitory computer readable medium including a computer program product for use by a video coding device, the computer program product including computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method includes: determining to apply a preprocessing function to visual media data as part of an image compression framework; and generating the bitstream based on the determining.

A fifth aspect relates to a method for storing bitstream of a video including: determining to apply a preprocessing function to visual media data as part of an image compression framework; generating the bitstream based on the determining; and storing the bitstream in a non-transitory computer-readable recording medium.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example framework of pre-processing based image compression.

FIG. 2 illustrates an example structure of a pre-processing module.

FIG. 3 is a block diagram showing an example video processing system.

FIG. 4 is a block diagram of an example video processing apparatus.

FIG. 5 is a flowchart for an example method of video processing.

FIG. 6 is a block diagram that illustrates an example video coding system.

FIG. 7 is a block diagram that illustrates an example encoder.

FIG. 8 is a block diagram that illustrates an example decoder.

FIG. 9 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present disclosure for case of understanding and do not limit the applicability of techniques and embodiments disclosed in each section only to that section. Furthermore, the embodiments described herein are applicable to other video codec protocols and designs.

### 1. Initial Discussion

This disclosure is related to image and/or video processing technologies. Specifically, it is about algorithm design for image pre-processing and compression. The ideas may be applied individually or in various combination, to any image and/or video coding system or part of coding and decoding process.

### 2. Further Discussion

Image compression plays a prominent role in handling the ever-increasing image data volume. A series of efforts are dedicated to improving compression efficiency in the literature and industry field. Lossy image compression standards including the Joint Photographic Experts Group (JPEG) version 2000 (JPEG2000). Better Portable Graphics (BPG), and Versatile Video Coding (VVC) are developed based on the block-wise hybrid coding framework. Such coding schemes include advanced prediction module, two-dimensional (2D) transformation, scalar quantization, arithmetic entropy coding, and loop filters, such that the redundant information in an image is efficiently eliminated.

Due to development of deep learning, learning-based strategies are available for use in conjunction with image compression. A Variational auto-encoder (VAE) may achieve beneficial compression performance in comparison to the coding standard methods, which demonstrates the compression potential of end-to-end optimized coding schemes. The end-to-end compression framework may involve convolution operations and Generalized Divisive Normalization (GDN), such that the visual signals are linearly and non-linearly transformed as the latent code and synthesized back to the reconstructed visual signals. The latent code is compressed into the bitstream with entropy coding. The network could be optimized in a globally end-to-end manner to target minimizing the rate and distortion cost. A series of efforts may enhance the rate distortion performance of end-to-end image compression. Advanced probabilistic estimation and entropy coding schemes may be used, such as the hyper-prior model, the joint auto-regressive model, and/or the entropy estimation with Gaussian mixture model. A vision transformer network may be applied to vision tasks, such as segmentation and restoration.

### 3. Technical Problems Solved by Disclosed Embodiments

Compression inevitably induces artifacts, especially in low bit-rate coding scenarios. A series of efforts are dedicated to investigating artifacts removal strategies as post-processing for better reconstruction quality. Fewer efforts are devoted to the pre-processing before compression. The merits of pre-processing lie in that the modification is applied to the encoder side, while keeping the decoder unchanged. The pre-processing is eligible to change the inputs according to the bit-rate budget or coding behaviors, which is anticipated to improve the overall rate-distortion performance. As such, designing pre-processing schemes for image and/or video compression may be beneficial.

### 4. A Listing of Solutions and Embodiments

To solve the above-described problems, methods as summarized below are disclosed. The embodiments should be considered as examples to explain the general concepts and should not be interpreted in a narrow way. Furthermore, these embodiments can be applied individually or combined in any manner. In the following descriptions, the term ‘image compression’ may represent any variance of signal processing methods that compress or process a current input. The input images and/or videos include, but are not limited to, the screen content and natural content. To solve the problems listed above, one or more of the following approaches are disclosed.

### Example 1

In an example, a preprocessing module is introduced to the image compression framework. The input of the preprocessing module is an image with size of W0×H0×C0, where W0 and H0 are the width and height of the image, respectively, and the C0 denotes the channel number. The output of the preprocessing module includes features or signals of the current image with size of W1×H1×C1.

### Example 2

In one example, W0, H0, and C0 are equal to W1, H1 and C1, respectively. In one example, C0 and C1 are equal to 3. In one example, C0 and C1 are equal to 1.

### Example 3

In one example, W0 and H0 are equal to W1 and H1, respectively. C0 is not equal to C1. In one example, C0 is equal to 3, and C1 is larger or smaller than C0. In one example, C0 is equal to 1, and C1 is larger than C0.

### Example 4

In one example, W0 and/or H0 may not be equal to W1 and/or H1. In one example, W1=W0/s, and H1=H0/s. C1=s×s×C0. In one example, s is equal to 2. In one example, s is equal to 4. In one example, W1=W0/s, and H1=H0/s. C1=C0. In one example, s is equal to 2. In one example, s is equal to 4.

### Example 5

In one example, the output of the preprocessing module may include features with different spatial dimensions.

### Example 6

In one example, the preprocessing module may comprise deep neural networks. The network parameters are obtained through learning.

### Example 7

In one example, convolutional layers are comprised in the preprocessing module. In one example, the kernel sizes may be 3×3, and/or 5×5, and/or 7×7. In one example, the dilated convolution may be used. In one example, multiple dilated convolutions may be applied, wherein the dilated parameters are set to 3, 5, and 7.

### Example 8

In one example, residual blocks are comprised in the preprocessing module. In one example, the residual blocks may contain a convolution layer, an activation layer, and a batch normalized layer. In one example, the batch normalized layer may be excluded from the residual blocks.

### Example 9

In one example, swin-transformers are comprised in the preprocessing module. In one example, the head number of swin-transformers is 2 and the depth is set to 2. In one example, the head number of swin-transformer is 6 and the depth is set to 6.

### Example 10

In one example, dense-connected structures are comprised in the preprocessing module.

### Example 11

In one example, a mixture of transformer networks, such as swin-transformer and convolutional layers, are comprised in the preprocessing module.

### Example 12

In one example, the network parameters of the preprocessing module may be obtained from another network, such as a visual geometry group network (vgg-net), a residual neural network (res-net), etc.

### Example 13

In one example, the preprocessing module may be jointly optimized with the compressor.

### Example 14

In one example, the compressor may be a learning-based variational auto-encoder. In one example, the preprocessing module and the variational auto-encoder may be jointly trained from scratch. In one example, the variational auto-encoder may be trained first. Then the preprocessing module and the variational auto-encoder are jointly trained. In one example, the variational auto-encoder may be trained first. Then the pre-processing module and the variational auto-encoder are jointly trained. Lastly, the preprocessing module is fixed, and the variational auto-encoder is finetuned.

In one example, a proxy auto-encoder with fixed model parameters is used to assist the training of the preprocessing network. In one example, multiple preprocessing modules may be provided, catering to different coding bitrates. In one example, only one preprocessing module is used, which is capable of adapting to different coding bitrates. In one example, quantization parameter maps may be used for guiding the preprocessing. In one example, the coding controlling parameter may be used for guiding the pre-processing.

### Example 15

In one example, the compressor may be a codec, such as JPEG, JPEG2000, high efficiency video coding (HEVC), VVC, audio video standard (AVS) version three (AVS3), AVS version two (AVS2), Advanced Video Coding (AVC) also known as H.264, and Alliance for Open Media Video 1 (AV1), etc. In one example, a proxy codec may be used when training the preprocessing module, which mimics the behaviors of other codecs. The proxy codec may contain a prediction module, transformation and inverse transformation modules, a quantization module, and a rate estimation module. In one example, the transformation is differentiable, which may be realized by discrete cosine transform (DCT), discrete sine transform (DST), and/or wavelet-domain transforms. In one example, the quantization can be realized with a k-order polynomial approximation. In one example, the rate estimation module may employ the L1-norm, L2-norm, L0-norm of the coefficients. In one example, L1-norm, L2-norm and L0-norm of the coefficients are linearly combined to estimate the coding bits. In one example, a deformation of L0-norm of the coefficients are used for rate estimation.

### Example 16

In one example, a restoration neural network may act as the proxy module that imitates the output of other codecs for training the preprocessing module. The proxy module may be appended after the pre-processing module. Moreover, a differentiable rate estimation module may be employed. In one example, the proxy module is trained by minimizing the distance between the reconstruction of traditional codec and the output of the proxy module. In one example, the distance may be measured by mean square error. In one example, the distance may be measured by the mean absolute error. In one example, the distance may be measured in feature domain, such as perceptual loss measured according to visual geometry group (VGG) neural network loss (VGG-loss). In one example, the distance may be measured by the structural similarity index (SSIM) loss.

In one example, the proxy module is fixed, and only the preprocessing module is trained by minimizing the distance between the original image and output images of the proxy module. In one example, the distance may be measured by mean square error. In one example, the distance may be measured by the mean absolute error. In one example, the distance may be measured in feature domain, such as perceptual loss (e.g., VGG-loss). In one example, the distance may be measured by the SSIM loss.

In one example, the proxy module is fixed, and only preprocessing module is trained. The rate loss is used and the distance between the original image and output images of the proxy module should be minimized.

### Example 17

In one example, the compressor may be a hybrid codec combined with learning-based modules, such as learning-based in-loop filters, learning-based intra prediction, learning-based inter prediction, learning-based quantization, etc. In one example, a proxy codec may be used when training the preprocessing module, which mimics the behaviors of the hybrid codec. The proxy codec may contain a prediction module, transformation and inverse transformation modules, a quantization module, and a rate estimation module. In one example, the transformation should be differentiable which may be realized by DCT. DST, and/or wavelet-domain transforms. In one example, the quantization can be realized with a k-order polynomial approximation. In one example, the rate estimation module may employ the L1-norm, L2-norm, L0-norm of the coefficients. In one example, L1-norm, L2-norm, and L0-norm of the coefficients are linearly combined to estimate the coding bits. In one example, a deformation of L0-norm of the coefficients are used for rate estimation.

### Example 18

In one example, the proxy codec may be used when training the preprocessing module, which may additionally contain learning-based in-loop filters, learning-based intra prediction, learning-based inter prediction, learning-based quantization, etc. In one example, the learning-based coding modules, such as learning-based in-loop filters, learning-based intra prediction, learning-based inter prediction, and learning-based quantization may be jointly optimized with the preprocessing module. In one example, the learning-based coding modules, such as learning-based in-loop filters, learning-based intra prediction, learning-based inter prediction, and learning-based quantization may be firstly pretrained and then jointly trained with the preprocessing module. In one example, the preprocessing module may be firstly trained with a proxy. Then the learning-based coding modules may be jointly trained with the preprocessing module.

### 5. Example Embodiments

Examples of preprocessing for image compression are illustrated as follows. A preprocessing module is integrated with the image compression framework, wherein the compressor could be learning-based codec or traditional codec. The inputs could be color pictures, frames, and/or videos with three channels, such as red green blue (RGB) and/or luma and chroma (YUV), or single channel pictures, frames, and/or videos.

A first example embodiment is now described.

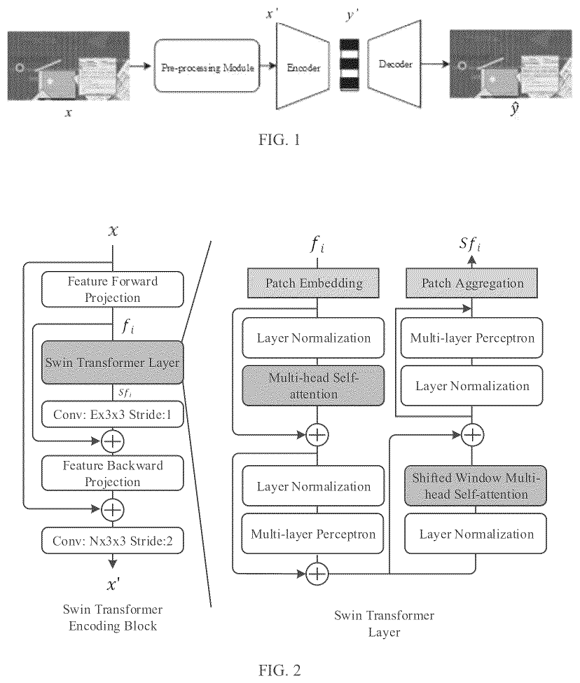

FIG. 1 illustrates an example framework of pre-processing based image compression. FIG. 2 illustrates an example structure of a pre-processing module. In this embodiment, a swin-transformer based pre-processing module is used in conjunction with an end-to-end image compression frame work. In particular, the input of the pre-processing module is a color image x with three channels (RGB or YUV), and the output of the pre-processing module is x′ with three channels. The reconstruction is denoted as y. The overall working flow is illustrated in FIG. 1, where a variant auto-encoder is employed for image compression. The framework of the preprocessing module is illustrated in FIG. 2.

The loss function can be formulated as follows:

$$L = λ [ {D}_{1} ( x , \hat{y} ) + {D}_{2} ( x , {x}^{′} ) ] + R ( {y}^{′} )$$

where A is the Lagrange parameter balancing the weights between rate and distortions. R (y′) denotes the rate of compressing y′. D₁ (x, ŷ) denotes the distance between x and ŷ, which may be measured by the mean square error. D₂ (x, x′) represents the distance between x and x′, which may be measured by the mean square error. The pre-processing module and the image compressor can be jointly optimized by minimizing the L, leading to the improvement of the rate-distortion performance.

A second example embodiment is now described.

In this embodiment, a swin-transformer based pre-processing module is used with an end-to-end image compression frame work, as shown in FIG. 1. The swin-transformer based pre-processing module is shown in FIG. 2. In particular, the input of the pre-processing module is a color image x with three channels (RGB or YUV), and the output of the pre-processing module is x′ with N channels. The loss function can be formulated as follows:

$$L = λ [ {D}_{1} ( x , \hat{y} ) + {D}_{3} ( p ( x ) , p ( {x}^{′} ) ) ] + R ( {y}^{′} )$$

where A is the Lagrange parameter balancing the weights between rate and distortions. R (y′) denotes the rate of compressing y′. D₁ (x, ŷ) denotes the distance between x and ŷ, which may be measured by the mean square error. D₃ (p (x), p (x′)) represents the perceptual distance between p (x) and p (x′), wherein p is the deep feature extractor. The pre-processing module and the image compressor can be jointly optimized by minimizing the L, leading to the improvement of the rate-distortion performance.

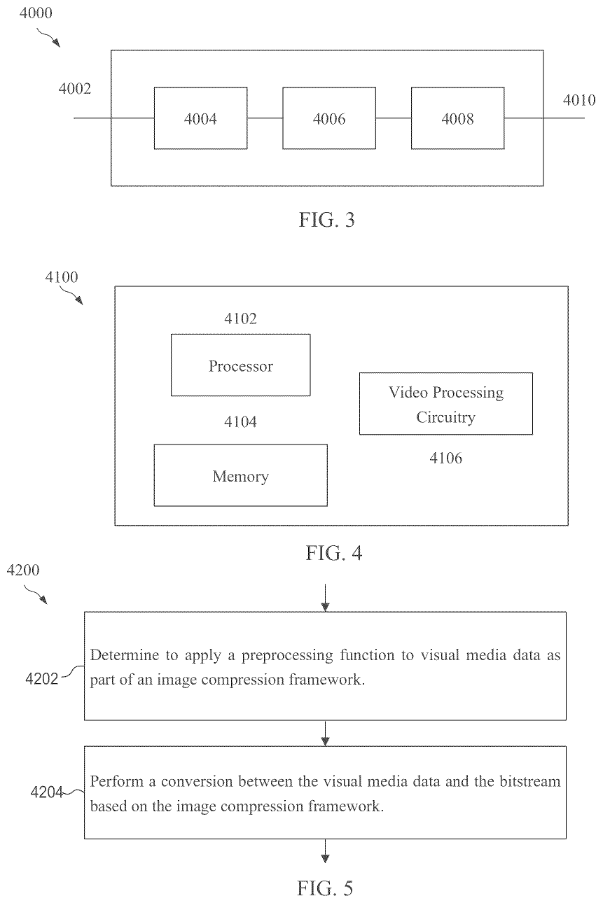

FIG. 3 is a block diagram showing an example video processing system 4000 in which various embodiments disclosed herein may be implemented. Various implementations may include some or all of the components of the system 4000. The system 4000 may include input 4002 for receiving video content. The video content may be received in a raw or uncompressed format, e.g., 8- or 10-bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present disclosure. The coding component 4004 may reduce the average bit-rate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or DisplayPort, and so on. Examples of storage interfaces include serial advanced technology attachment (SATA), peripheral component interconnect (PCI), integrated drive electronics (IDE) interface, and the like. The embodiments described in the present disclosure may be embodied in various electronic devices such as mobile phones, laptops, smartphones or other devices that are capable of performing digital data processing and/or video display.

FIG. 4 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and embodiments described herein. The video processing circuitry 4106 may be used to implement, in hardware circuitry, some embodiments described in the present disclosure. In some embodiments, the video processing circuitry 4106 may be at least partly included in the processor 4102, e.g., a graphics co-processor.

FIG. 5 is a flowchart for an example method 4200 of video processing. The method 4200 includes determining to apply a preprocessing function to visual media data as part of an image compression framework at step 4202. A conversion is performed between a visual media data and a bitstream based on the image compression framework at step 4204. The conversion of step 4204 may include encoding at an encoder or decoding at a decoder, depending on the example.

It should be noted that the method 4200 can be implemented in an apparatus for processing video data including a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium including a computer program product for use by a video coding device. The computer program product comprises computer executable instructions stored on the non-transitory computer readable medium such that when executed by a processor cause the video coding device to perform the method 4200.

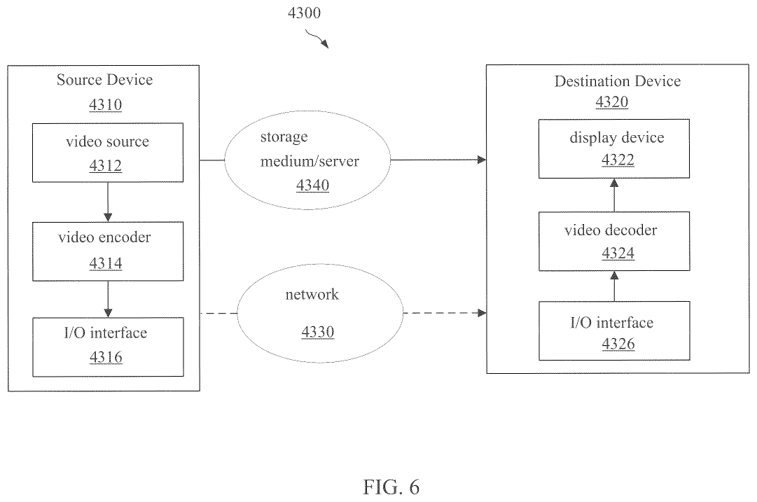

FIG. 6 is a block diagram that illustrates an example video coding system 4300 that may utilize the embodiments of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

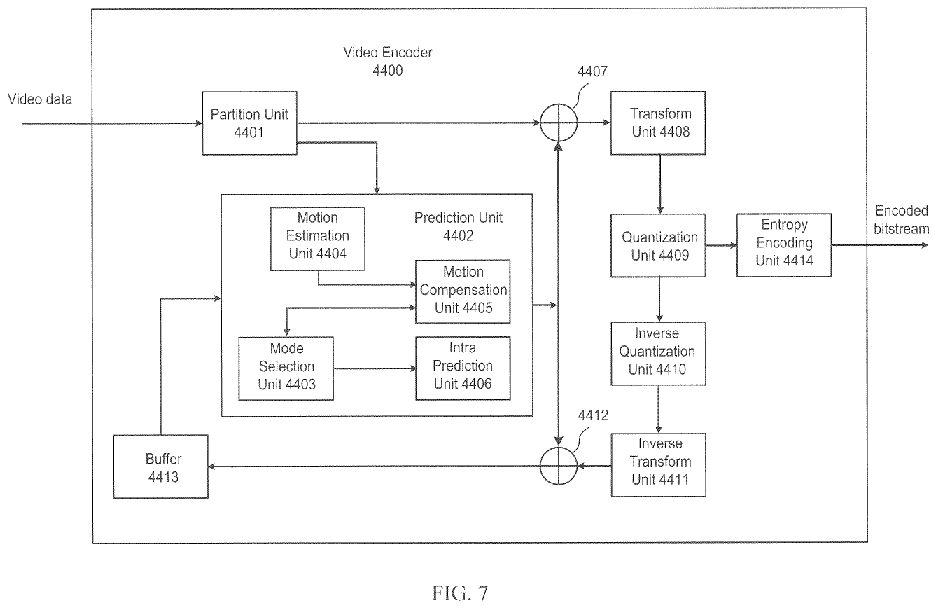

FIG. 7 is a block diagram illustrating an example of video encoder 4400, which may be video encoder 4314 in the system 4300 illustrated in FIG. 6. Video encoder 4400 may be configured to perform any or all of the embodiments of this disclosure. The video encoder 4400 includes a plurality of functional components. The embodiments described in this disclosure may be shared among the various components of video encoder 4400. In some examples, a processor may be configured to perform any or all of the embodiments described in this disclosure.

The functional components of video encoder 4400 may include a partition unit 4401; a prediction unit 4402, which may include a mode select unit 4403, a motion estimation unit 4404, a motion compensation unit 4405, and an intra prediction unit 4406; a residual generation unit 4407; a transform processing unit 4408; a quantization unit 4409; an inverse quantization unit 4410; an inverse transform unit 4411; a reconstruction unit 4412; a buffer 4413; and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

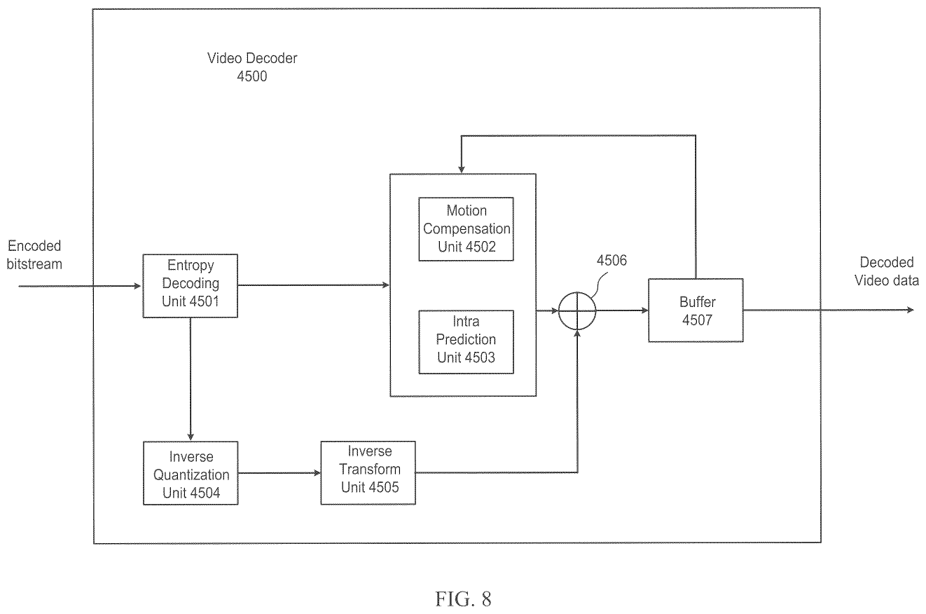

FIG. 8 is a block diagram illustrating an example of video decoder 4500 which may be video decoder 4324 in the system 4300 illustrated in FIG. 6. The video decoder 4500 may be configured to perform any or all of the embodiments of this disclosure. In the example shown, the video decoder 4500 includes a plurality of functional components. The embodiments described in this disclosure may be shared among the various components of the video decoder 4500. In some examples, a processor may be configured to perform any or all of the embodiments described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes. i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

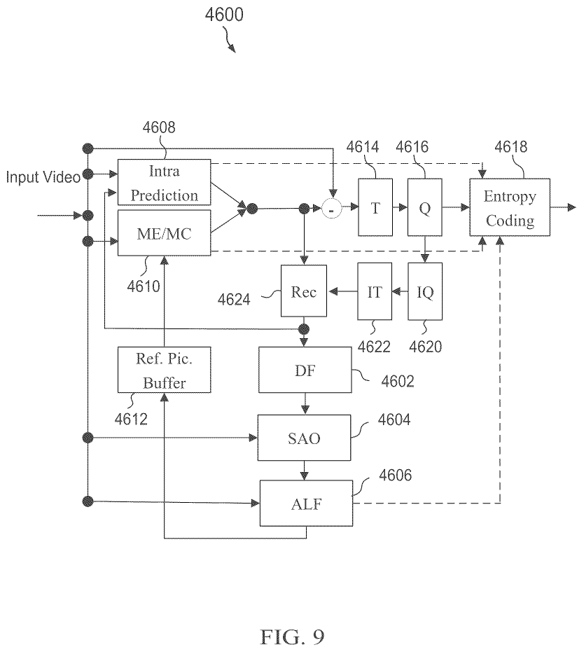

FIG. 9 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of embodiments discussed herein.

1. A method for processing video data (e.g., method 4200 depicted in FIG. 5) including: determining (4202) to apply a preprocessing function to visual media data as part of an image compression framework; and performing (4204) a conversion between a visual media data and a bitstream based on the image compression framework.

2. The method of solution 1, wherein the preprocessing function receives a current image of size W0×H0×C0, where W0 is an input width, H0 is an input height, and C0 is an input channel number, and wherein the preprocessing function outputs the current image with a size of W1×H1×C1, where W1 is an output width, H1 is an output height, and C1 is an output channel number.

3. The method of any of solutions 1-2, wherein W0 is equal to W1, H0 is equal to H1, and C0 is equal to C1.

4. The method of any of solutions 1-3, wherein C0 is not equal to C1.

5. The method of any of solutions 1-4, wherein W0 is not equal to W1 or H0 is not equal to H1.

6. The method of any of solutions 1-5, wherein the preprocessing function includes a deep neural network that employs parameters determined through deep learning.

7. The method of any of solutions 1-6, wherein the preprocessing function includes convolutional layers that employ a kernel size of 3×3, 4×5, or 7×7, and wherein the convolutional layers employ dilated convolution with a dilated parameter set to three, five, or seven.

8. The method of any of solutions 1-7, wherein the preprocessing function includes residual blocks, wherein the residual blocks contain a convolutional layer, an activation layer, a batch normalization layer, or combinations thereof.

9. The method of any of solutions 1-8, wherein the preprocessing function includes swin-transformers, and wherein a head number of the swin-transformers is two or six, and wherein a depth of the swin-transformers is set to two or six.

10. The method of any of solutions 1-9, wherein the preprocessing function includes dense connected structures.

11. The method of any of solutions 1-10, wherein the image compression framework includes a compressor, and wherein the preprocessing function is jointly optimized with the compressor.

12. The method of any of solutions 1-11, wherein the compressor is a learning based variational auto-encoder.

13. The method of any of solutions 1-12, wherein the learning based variational auto-encoder is partially trained prior to training the preprocessing function, and wherein the learning based variational auto-encoder and the preprocessing function are jointly trained.

14. The method of any of solutions 1-13, wherein the compressor is a proxy auto encoder with fixed model parameters.

15. The method of any of solutions 1-14, wherein the preprocessing function includes multiple models directed to different coding bit rates.

16. The method of any of solutions 1-15, wherein the preprocessing function is configured to adapt to different bitrates based on a quantization parameter, a coding controlling parameter, or combinations thereof.

17. The method of any of solutions 1-16, wherein the proxy auto encoder includes a prediction function, a transformation function, an inverse transformation function, a quantization function, and a rate estimation function.

18. The method of any of solutions 1-17, wherein the proxy auto encoder includes a restoration neural network.

19. The method of any of solutions 1-18, wherein the compressor includes a hybrid codec that further includes a codec and a learning-based function, and wherein the learning-based function includes learning-based in-loop filters, learning-based intra prediction, learning-based inter prediction, learning-based quantization, or combinations thereof.

20. An apparatus for processing video data including: a processor; and a non-transitory memory with instructions thereon, wherein the instructions upon execution by the processor, cause the processor to perform the method of any of solutions 1-19.

21. A non-transitory computer readable medium including a computer program product for use by a video coding device, the computer program product including computer executable instructions stored on the non-transitory computer readable medium such that when executed by a processor cause the video coding device to perform the method of any of solutions 1-19.

22. A non-transitory computer-readable recording medium storing a bitstream of a video which is generated by a method performed by a video processing apparatus, wherein the method comprises: determining to apply a preprocessing function to visual media data as part of an image compression framework; and generating the bitstream based on the determining.

23. A method for storing bitstream of a video including: determining to apply a pre-processing function to visual media data as part of an image compression framework; generating the bitstream based on the determining; and storing the bitstream in a non-transitory computer-readable recording medium.

24. A method, apparatus, or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a non-transitory computer readable medium for execution by, or to control the operation of, data processing apparatus. The non-transitory computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question. e.g., code that constitutes processor firmware, a protocol stack, a database management system, an operating system, or a combination of one or more of them. A propagated signal is an artificially generated signal. e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field-programmable gate array (FPGA) or an application-specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing video data, comprising:
performing a conversion between visual media data and a bitstream of the visual media data by an image compression framework,
wherein the image compression framework comprises a preprocessing function and a compressor, and the visual media data is processed by the preprocessing function and the compressor sequentially, and
wherein the preprocessing function receives a first image among the visual media data with a size of W0×H0×C0 as input and outputs a preprocessed first image with a size of W1×H1×C1, wherein W0 is an input width, H0 is an input height, and C0 is an input channel number, and wherein W1 is an output width, H1 is an output height, and C1 is an output channel number.

2. The method of claim 1, wherein W0 is equal to W1, H0 is equal to H1, and C0 is equal to C1.

3. The method of claim 1, wherein W0 is equal to W1, H0 is equal to H1, and C0 is not equal to C1.

4. The method of claim 1, wherein the preprocessed first image output by the preprocessing function comprises features with different spatial dimensions.

5. The method of claim 1, wherein the preprocessing function includes a deep neural network that employs parameters determined through deep learning, and
wherein the preprocessing function includes convolutional layers that employ a kernel size of 3×3, 5×5, or 7×7, and the convolutional layers include dilated convolution with a dilated parameter set to three, five, or seven.

6. The method of claim 1, wherein the preprocessing function includes residual blocks, wherein the residual blocks comprise at least one of the group consisting of a convolutional layer, an activation layer, and a batch normalization layer.

7. The method of claim 1, wherein the preprocessing function includes a swin-transformer, wherein a head number of the swin-transformer is two or six, and wherein a depth of the swin-transformer is set to two or six.

8. The method of claim 1, wherein the preprocessing function is jointly optimized with the compressor.

9. The method of claim 8, wherein the compressor comprises a learning based variational auto-encoder, and wherein the preprocessing function and the variational auto-encoder are jointly trained from scratch.

10. The method of claim 8, wherein the compressor comprises a learning based variational auto-encoder, wherein the learning based variational auto-encoder is partially trained prior to training the pre-processing function, and wherein the learning based variational auto-encoder after being partially trained and the preprocessing function are jointly trained.

11. The method of claim 8, wherein the compressor comprises a proxy auto encoder with fixed model parameters for assisting training of the preprocessing function, and wherein the proxy auto encoder includes a prediction function, a transformation function, an inverse transformation function, a quantization function, and a rate estimation function.

12. The method of claim 1, wherein the preprocessing function includes multiple models directed to different coding bit rates.

13. The method of claim 1, wherein the preprocessing function is configured to adapt to different coding bit rates based on a quantization parameter, a coding controlling parameter, or a combination thereof.

14. The method of claim 11, wherein the transformation function comprises at least one of the group consisting of a discrete cosine transform (DCT), a discrete sine transform (DST), and a wavelet-domain transform,
wherein the quantization function comprises a k-order polynomial approximation process, and
wherein the rate estimation function employs L1-norm, L2-norm, L0-norm of coefficients of the transformation function.

15. The method of claim 11, wherein the proxy auto encoder is a restoration neural network for assisting the training the preprocessing function, and wherein the preprocessing function is trained based on minimizing a distance between an input image of the proxy auto encoder and an output image of the proxy auto encoder.

16. The method of claim 1, wherein the compressor comprises a hybrid codec that further includes a codec and a learning-based function, and wherein the learning-based function includes at least one of the group consisting of a learning-based in-loop filter, learning-based intra prediction, learning-based inter prediction, and learning-based quantization.

17. The method of claim 1, wherein the conversion includes encoding the visual media data into the bitstream.

18. The method of claim 1, wherein the conversion includes decoding the visual media data from the bitstream.

19. An apparatus for processing visual media data comprising a processor and a non-transitory memory with instructions thereon, wherein the instructions upon execution by the processor, cause the processor to:
perform a conversion between visual media data and a bitstream of the visual media data by an image compression framework,
wherein the image compression framework comprises a preprocessing function and a compressor, and the visual media data is processed by the preprocessing function and the compressor sequentially, and
wherein the preprocessing function receives a first image among the visual media data with a size of W0×H0×C0 as input and outputs a preprocessed first image with a size of W1×H1×C1, wherein W0 is an input width, H0 is an input height, and C0 is an input channel number, and wherein W1 is an output width, H1 is an output height, and C1 is an output channel number.

20. A non-transitory computer-readable recording medium storing a bitstream of visual media data which is generated by a method performed by a video processing apparatus, wherein the method comprises:
generating the bitstream of the visual media data by an image compression framework,
wherein the image compression framework comprises a preprocessing function and a compressor, and the visual media data is processed by the preprocessing function and the compressor sequentially, and
wherein the preprocessing function receives a first image among the visual media data with a size of W0×H0×C0 as input and outputs a preprocessed first image with a size of W1×H1×C1, wherein W0 is an input width, H0 is an input height, and C0 is an input channel number, and wherein W1 is an output width, H1 is an output height, and C1 is an output channel number.
